(19) United States
(12) Patent Application Publication
(10) Pub. No.: US 2026/0216632 A1
(43) Pub. Date: Jul. 30, 2026

(54) Water Oxygenation System, Flow Block, and External Replaceable Nitrogen Filter Cartridge

(71) Applicants: Johnny Johnson, Rogersville, AL (US); Mark Owens, Athens, AL (US); Edward Guice, Decatur, AL (US)

(72) Inventors: Johnny Johnson, Rogersville, AL (US); Mark Owens, Athens, AL (US); Edward Guice, Decatur, AL (US)

(21) Appl. No.: 19/462,292

(22) Filed: Jan. 28, 2026

Related U.S. Application Data
(60) Provisional application No. 63/751,238, filed on Jan. 29, 2025.

(51) Int. Cl. B01D 53/04; B01D 46/00; B01D 53/26; B01F 23/237; B01F 23/70; B01F 101/00

(52) U.S. Cl. CPC B01D 53/0415; B01D 46/0036; B01D 53/0438; B01D 53/0446; B01D 53/0454; B01D 53/261; B01F 23/237612; B01F 23/704; B01F 23/708; B01D 2253/108; B01D 2253/11; B01D 2256/12; B01D 2257/102; B01D 2257/80; B01D 2259/40086; B01D 2259/402; B01F 2101/305

(57) ABSTRACT

A water oxygenation system having two filter cartridges, each filter cartridge having a cartridge body and a cartridge cap containing at least two felt discs, a nitrogen scrubbing material, at least two disc springs, and a steel wave spring. A desiccant can be included in each filter cartridge. The system includes a flow block assembly having a flow block, two bullet valves, and at least two compression devices, and a housing having a base plate 21, a printed circuit board, a heat exchanger fan 22, a 4 way valve 18, two electric solenoid valves, a compressor 10 connected together and with the two filter cartridges to produce oxygen enriched air.

### BACKGROUND OF THE INVENTION

### Field of the Invention

This invention relates to the generation and introduction of oxygen into an aqueous media, mainly water, for increasing the oxygen content to an almost if not total oxygen saturation or supersaturated level in that aqueous media. The invention uses this highly oxygenated water or aqueous media to help fish or aquatic life sustain life, increase plant growth, increase soil and soil water oxygen levels, help in wastewater treatment plants process waste material, industrial oxygen usages and medical oxygen.

### Description of the Related Art

Many benefits are obtained through raising the oxygen content of water found in portable or permanent reservoirs designed to hold aquatic or plant life. Efforts have been made to achieve higher saturation levels, or supersaturated oxygen levels for applications such as the improvement of water quality in ponds, lakes, marshes and reservoirs, help detoxification of contaminated water, fish, bait fish, game fish, catfish, saltwater species and other aquatic animals. Most fishing boats have a livewell or baitwell that are installed and intended to keep fish and or baitfish alive for consumption, bait or for release at a time later than the time at which the fish were caught. Most livewell or baitwell systems installed in boats are not effective or efficient in sustaining oxygen levels high enough to sustain and or promote good health of the catch or creel. It is a biological/scientific fact that the more weight of fish or oxygen using biological life put into a fixed capacity livewell or baitwell the more demand there is on the oxygen levels in the water needed to sustain life. These same systems, per multiple scientific studies seeking to determine the rate of fish mortality at any given water temperature or oxygen content, have proven that fish and aquatic life that is exposed to an oxygen deficient environment can have an immediate high level of mortality as well as a high level of mortality for a delayed or post release time frame. The stress on game fish, baitfish, catfish, saltwater species and other fish, especially in warm weather, is extreme during warmer weather leading to confirmed high mortality rates even after the fish have been released. Many times, fish die days after being released because of oxygen deprivation and stress that was incurred while the fish were placed in fish tanks or livewells or baitwells with low levels of oxygen in the water. Mortality of marine life, mainly game fish, both during and in the days after release from tournaments and fishing events has proven that the most popular livewell and or baitwell aerating systems are inadequate to adequately sustain the fish with sufficient oxygen levels during the time of the tournament or fishing event. University studies have proven that stress on livewell held fish, bass in particular, due to stress, oxygen deprivation, and turbidity inside a livewell, leads to delayed mortality at a much higher rate than what is commonly known or understood by the general public.

For example, fish held in a limited environment such as an aquarium, a bait bucket or a live hold tank quickly use up the dissolved oxygen in the course of normal respiration and are then subject to hypoxic stress, which can lead to death. A similar effect is seen in cell cultures, where the respiring cells would benefit from higher oxygen content of the medium. Contaminated or oxygen deprived water is described as having an increased biological oxygen demand (BOD) and water treatment or oxygenating is aimed at decreasing the BOD so as to make more oxygen available for fish and other life forms.

The most common method of increasing the oxygen content of a medium is by spraying water with air or oxygen. While this is a simple method, the resulting large bubbles produced by simple air introduction under pressure rapidly rise to the surface and are discharged or dissipated into the atmosphere and does not saturate water or medium with oxygen. When the object of generating bubbles is to oxygenate the water, air with an oxygen content of about 21% may be used, but under many conditions an oxygen level as low as 21% used in bubble generation is found to be inadequate to sustain life. However, water or medium does not become fully saturated and Parts Per Million (ppm) quickly goes down when spraying device is stopped. The production of oxygen with a byproduct of hydrogen for use in livewells and waste water treatment by the electrolysis of water is well known. However, the rate of oxygen production required to keep fish or aquatic life vibrant and healthy is based on a matrix formula. The matrix would have multiple factors influencing the outcome such as the volume of animal life in the tank compared to the volume of water inside the livewell or tank as well as the temperature of the water in a livewell which determines the rate at which the oxygen found in the water has been used up by the aquatic life and must be replaced by oxygen introduction. The oxygen introduced into the water is helped by reducing the bubble size which helps to elevate the rate of ppm levels in the water and can help respiratory absorption by the fish or aquatic life. The addition of oxygen in a livewell or tank that holds or stores aquatic life is imperative anytime the oxygen saturation levels fall below a threshold of 4 ppm, the readily accepted minimum for fish survival. An undesirable effect of an electrolysis system oxygen generating systems in livewells or baitwells commonly found in boats and tanks where aquatic life needs to have the oxygen levels augmented artificially, is that hydrogen gas is produced at the cathode along with the targeted oxygen gas that the electrolysis process was intended to produce.

Holding vessels for live aquatic life tend to have a high population which use up the available oxygen rapidly. Pumps to supply oxygen have high power requirements and the noise and bubbling may further stress the aquatic life. The available electrolytic generators which are capable of producing adequate oxygen levels, likewise have high power requirements and additionally run at high voltages and produce acidic and hydrogen rich water which is detrimental to the very aquatic life the system is supposed to help or sustain. Many of the oxygenating systems designed to keep baitfish, caught fish or aquatic species alive, would benefit from portable devices that did not require a source of high power and undesirable off-gasses. The need remains for a relatively quiet, portable or permanent, and a low voltage system to highly oxygenate the water within these livewell, baitwell or holding tanks in order to improve the life and viability of aquatic life being held.

### SUMMARY OF THE INVENTION

One primary objective of the present invention is to provide an oxygenation system which provides a high level of oxygen to a livewell, baitwell or holding tank. The oxygenation system uses a controller which is a combination of a housing fixture or control box, a base plate which the components are connected, a printed circuit board which programed, a compressor, heat exchanger with fan to cool heat exchanger, fan(s) to provide cooling air across the air compressor and supply air in and out of the housing, filter cartridges which contains a chemical scrubbing material, a machined or injection molded self-contained flow block, a 4 way valve, electric solenoid valves, compressor isolators which the compressor connects, Wago wire connectors, 4 way valve wire pigtail, exhaust filter connect to the 4 way valve, compressor intake filter, at least one housing vent with a cooling fan, cable glands and cable gland plugs in be used for power cord and tubing to enter and exit the housing, series of components are connect together with tubing to allow air passage to generate oxygen.

A further objective of the present invention is to provide an oxygenation system that provides a high concentrated level of oxygen in volumes and pressures necessary to saturate or super-oxygenate the water in the tank or reservoir of aqueous medium.

Another objective of the present invention is to provide an oxygenation system that can be sized for virtually any size application based on oxygen need of the aqueous medium, as well as being contingent upon the need to saturate or super-saturate any given volume of water in a set time period regardless of the amount of game fish, baitfish or aquatic life in the livewell, baitwell or holding tank.

A further objective of the present invention is to provide an oxygenation system that can also be assembled without the housing or box in case space permits the components to be built in or added to an existing vessel or facility where the housing or box is not wanted or is not necessary for protecting the interior components of the system.

Another objective of the present invention is to provide an oxygenation system wherein the filter cartridges are separate units and not part of the flow block but connected through fittings and tubing have been designed to maximize a flow of air through the filter cartridges via porting in the flow block. Filter cartridges containing chemicals that readily absorb nitrogen under pressure are part of this invention. The filter cartridges will need to be replaced when the chemical media contained within the filter cartridges becomes contaminated or ineffective due to fouling of the absorbent pores of the media from foreign matter contained within the supply air stream and being a separate part are easily replaced with new filter cartridge with fresh media.

Another objective of this invention is to provide an oxygenation system that will provide highly oxygenated or super saturated oxygenated water or aqueous solutions to improve oxygen soil levels and/or soil oxygen concentration, improve ground water oxygen levels and/or ground water oxygen concentration, provide highly oxygenated or super saturated oxygenated water or aqueous solutions for improved hydroponic plant growth and plant production and provide highly oxygenated or super saturated oxygenated water or aqueous solutions to enhance and improve waste water treatment facilities by infusing this highly saturated water or aqueous solutions into the waste water treatment turnover process thus causing an increase in efficiency and reducing turnover rate time.

### BRIEF DESCRIPTION OF THE DRAWINGS

FIG. 1 is a side view of the present invention.

FIG. 2 is a side view of the unit control box of the present invention.

FIG. 3 is a top view of the unit control box of the present invention.

FIG. 4 is a first side view of the components of the unit control box of the present invention.

FIG. 5 is a top view of the components of the unit control box of the present invention.

FIG. 6 is a second side view of the components of the unit control box of the present invention.

FIG. 7A is a side view of the Small Filter Cartridge of the present invention.

FIG. 7B is a top view of the Small Filter Cartridge of the present invention.

FIG. 7C is section view of the Small Filter Cartridge of the present invention.

FIG. 8A is a side view of the Large Filter Cartridge of the present invention.

FIG. 8B is a top view of the Large Filter Cartridge of the present invention.

FIG. 8C is section view of the Large Filter Cartridge of the present invention.

FIG. 9 is an exploded view of the flow block of the present invention.

FIG. 10 is an end view of the flow block of the present invention.

FIG. 11 is a side view of the flow block of the present invention.

FIG. 12 is a side view of the flow block of the present invention.

FIG. 13 is a side view of the flow block of the present invention.

FIG. 14 is an end view of the flow block of the present invention.

FIG. 15 is a section view of the present invention with the bullet valves located in the first position.

FIG. 16 is a section view of the present invention with the bullet valves located in the second position.

FIG. 17 is a diagram showing the air flow through the components of the present invention with the bullet valves located in the first position.

FIG. 18 is a diagram showing the air flow through the components of the present invention with the bullet valves located in the second position.

### DETAILED DESCRIPTION OF THE PREFERRED EMBODIMENTS

### Water Oxygenation System - Assembly of the Water Oxygenation System

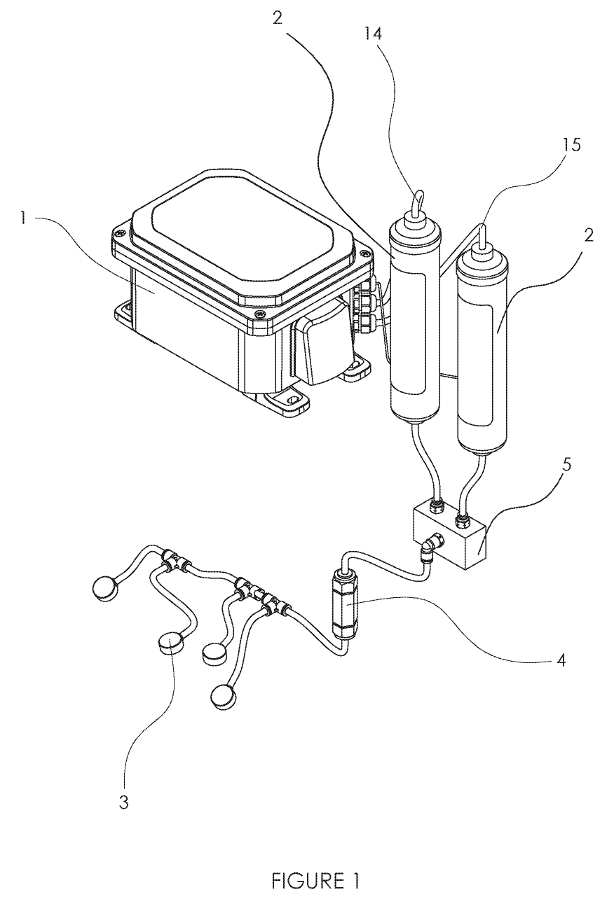

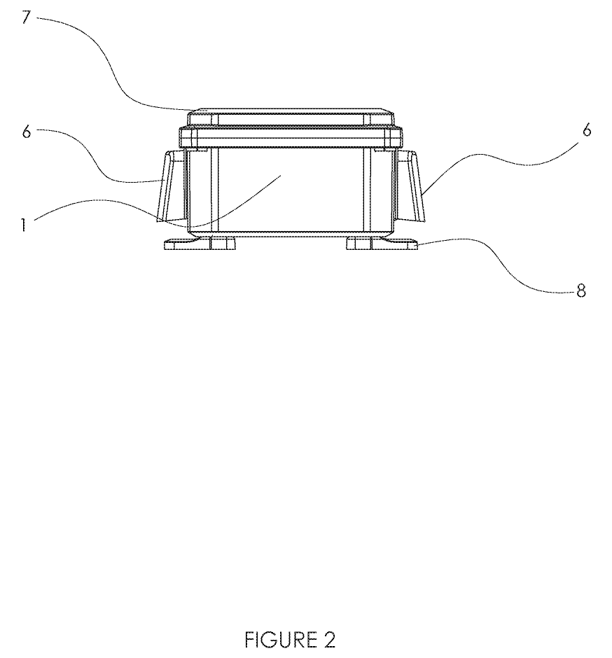

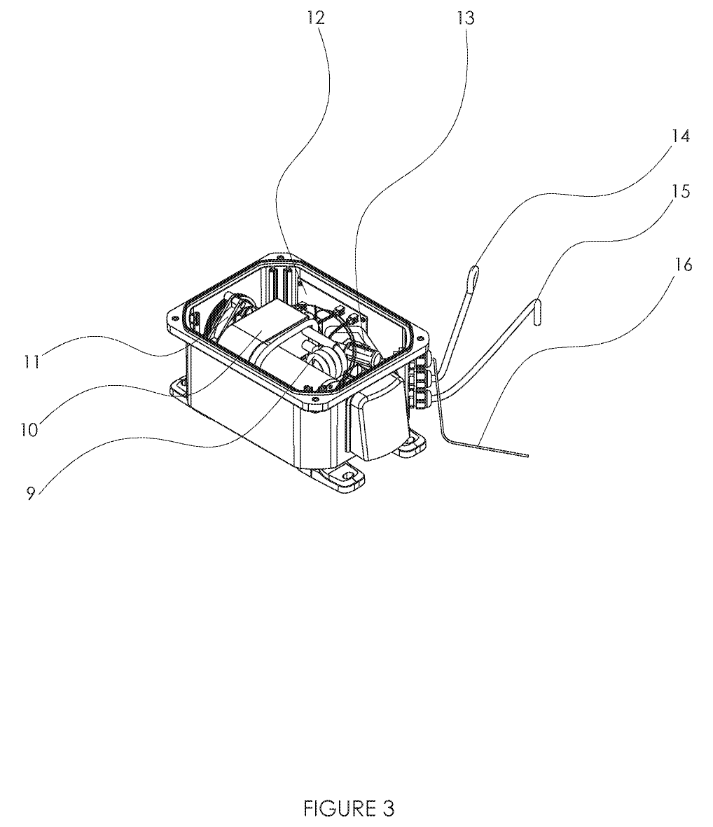

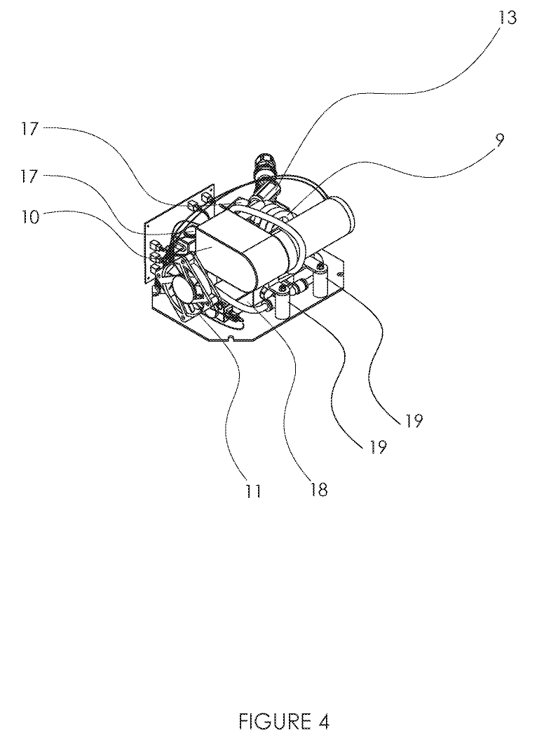

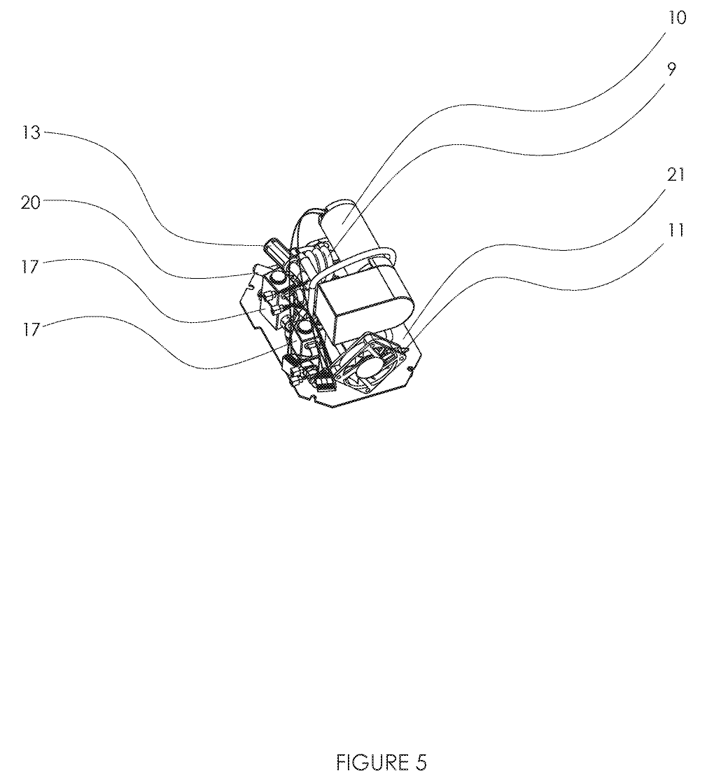

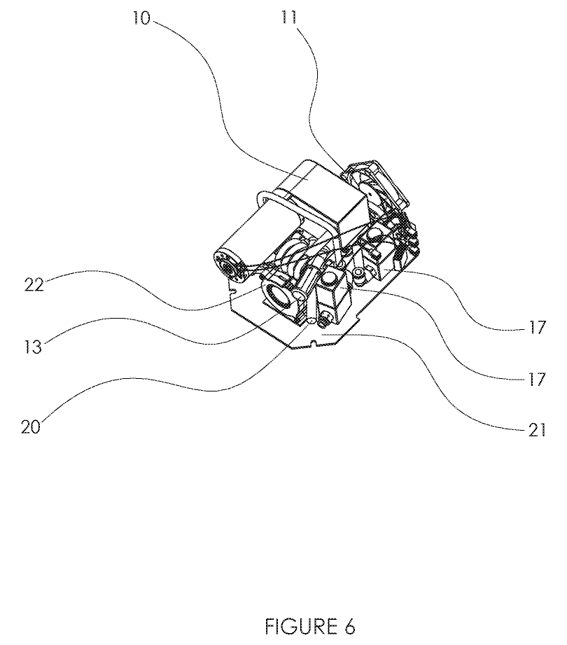

As shown in FIGS. 1-6, a water oxygenation system that includes a base plate 21, a printed circuit board 12, a heat exchanger fan 22 (cooling coil fan), a 4 way valve 18, two electric solenoid valves 17, four compressor mounting isolators 19, tubing, a compressor 10 to provide compressed air and a pressurized air flow, two Wago wire connectors (2 units), a wire pigtail for the 4 way valve 18, a heat exchanger 9 (cooling coil) with connector and tubing, an exhaust filter 20 for the 4 way valve 18, a compressor intake filter 13, a housing 1 (control box), at least one housing vent, at least one housing cooling fan 11, three cable glands (3 units) and cable gland plugs, power cord 16, tubing (can be 5/16 inch or 8mm or any suitable diameter), two filter cartridges 2, and a flow block assembly 5.

The base plate 21 is the mounting platform for the water oxygenation system’s components to be mounted and connected together. The printed circuit board 12 is connected to the base plate 21. The heat exchanger fan 22 is connected to base plate 21 and heat exchanger fan 22 is plugged into the printed circuit board 12. The heat exchanger fan 22 blows air across the heat exchanger 9 to remove heat from the air flowing through the heat exchanger 9. The heat exchanger 9 is made of metal, copper, copper alloy, or other suitable material to provide a transfer of heat from the air flow. The 4 way valve 18 is connected to the base plate 21 and a wire pigtail of the 4 way valve 18 is plugged into the printed circuit board 12. The two electric solenoid valves 17 are connected to base plate 21, wired into the Wago connectors, and each electric solenoid valve inlet port is connected to the 4 way valve 18 outlet ports with tubing. The four compressor mounting isolators 19 are connected to base plate 21 and are connected to the compressor 10. The tubing (can be 5/16 inch or 8mm or any suitable diameter) is used to connect components together for air to pass through these tubing lines and components to generate oxygen. The components connected by tubing include the compressor 10, the heat exchanger 9, the 4 way valve 18, the two electric solenoid valves 17, the two filter cartridges 2, the flow block 50, the compressor intake filter 13, and the exhaust filter 20 connected to the 4 way valve 18. The compressor 10 is connected to the four compressor mounting isolators 19 and the compressor 10 is wired into the Wago connectors with positive and negative wires. The two Wago wire connectors are connected to the positive and negative wires of the compressor 10 and the positive and negative wires of each of the two electric solenoid valves 17. The wire pigtail of the 4 way valve 18 is connected to the printed circuit board 12 and connects the 4 way valve 18 to the printed circuit board 12. A heat exchanger inlet of the heat exchanger 9 is connected to a compressor outlet of the compressor 10 with tubing and a heat exchanger outlet of the heat exchanger 9 is connected with tubing to a 4 way valve inlet port of the 4 way valve 18. The exhaust filter 20 is connected by tubing to an exhaust port of the 4 way valve 18. The compressor intake filter 13 connects to the intake port of the compressor 10 with tubing. The housing 1 is the enclosure which houses all the water oxygenation system’s internal components. The housing 1 includes a housing lid 7 and at least one mounting feet 8. Four mounting feet 8 for positioning the housing 1 in a predetermined position are shown in the figures. A housing lid 7 removably covers and seals the housing 1. The at least one housing vent 6 includes at least one ventilation cover and an opening. The opening communicates with the interior and the exterior of the housing 1. The water oxygenation system is shown with two housing vents 6, each housing vent 6 is connected to one housing cooling fan 11. The two housing vents 6 are connected to an opening located at either end of the housing 1 and the housing cooling fan 11 is connected to one end of the housing 1 at the housing vent 6 and wiring of the housing cooling fan 11 is electrically connected to the printed circuit board 12. The housing cooling fan 11 moves air through the housing 1 and the two housing vents to remove heat from and prevent heat build-up in the housing 1. The cable glands and cable gland plugs are connected through a side wall of the housing 1. The power cord 16 enters the housing 1 through one of the cable glands and has positive and negative wires connected into the two Wago connectors to provide power. The output tubing line 14 and output tubing line 15 are inserted through the cable glands on the side of the unit control box and enter the unit control box to connect each filter cartridge 2 of the two filter cartridges 2 to a corresponding electrical solenoid valve output port of each electric solenoid valve 17 of the two electric solenoid valves 17. The output tubing line 14 and output tubing line 15 leave the housing 1 through the cable glands and each output tubing line 14, 15 is connected to the inlet port of a corresponding one of the two filter cartridges 2. Each filter cartridge 2 is connected by tubing from the filter cartridge outlet port 24 to one of two flow block inlet ports 54a, 54b of the flow block 50 by tubing. Flow block inlet ports 54a, 54b are connected to corresponding filter cartridge outlet ports 24 by tubing and a flow block outlet port 58 is connected to tubing which is connected to the one way check valve 4 that is connected to the at least one defusing stones 3 which releases oxygen when all the components are connected and the water oxygenation system is powered and turned on. The drawings are shown with four defusing stones 3.

The printed circuit board 12 is electrically connected to and controls the compressor 10, the heat exchanger fan 22, the 4 way valve 18, and the two electric solenoid valves 17. The printed circuit board 12 turns the compressor 10 on and off and controls the amount of air that flows from the compressor 10. The printed circuit board 12 turns the heat exchanger fan 22 on and off and controls the amount of air flow through the heat exchanger fan 22. The printed circuit board 12 controls the 4 way valve 18 and opens and closes the valves of the 4 way valve 18 to control the air flow from the compressor 10, the air flow to and from the two electric solenoid valves 17, and the air flow exiting from the exhaust port of the 4 way valve 18.

The 4 way valve 18 switch is moveable between a first and a second position. When the 4 way valve 18 is located in the first position, the flow from the inlet port of the 4 way valve 18 exists a first outlet port of the 4 way valve 18 and flow from a second outlet port of the 4 way valve 18 flows out the exhaust port of the 4 way valve 18. When the 4 way valve 18 is located in the second position, the flow from the inlet port of the 4 way valve 18 exists the second outlet port of the 4 way valve 18 and flow from the first outlet port of the 4 way valve 18 flows out the exhaust port of the 4 way valve 18.

The two electric solenoid valves 17 control the amount of air flow moving into and out of the two filter cartridges 2 in both a forward direction and a reverse direction. When the two electric solenoid valves 17 are energized, each electric solenoid valve of the two electric solenoid valves 17 is open and air is allowed to flow between the 4 way valve 18 and the corresponding filter cartridge 2 of the two filter cartridges 2. When the two electric solenoid valves 17 are powered off or have no power, each electric solenoid valve 17 of the two electric solenoid valves 17 is closed and air is prevented from flowing between the 4 way valve 18 and the corresponding filter cartridge of the two filter cartridges 2 to prevent contamination and degradation of the nitrogen scrubbing material 27 (zeolite or other suitable material).

### Flow Block Description

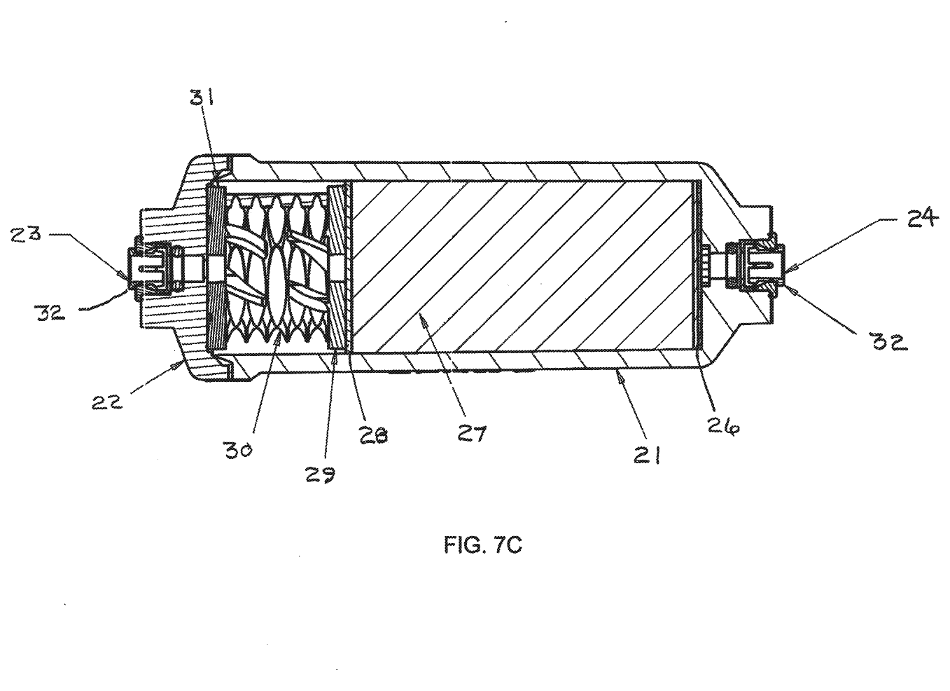

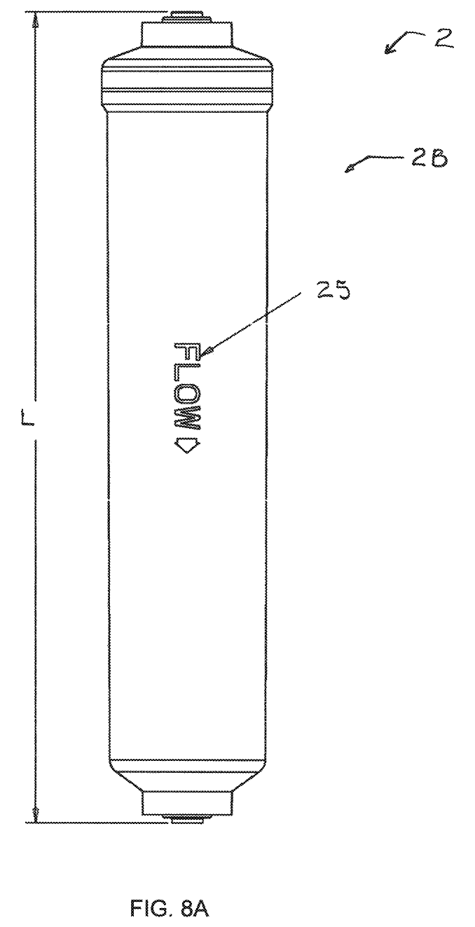

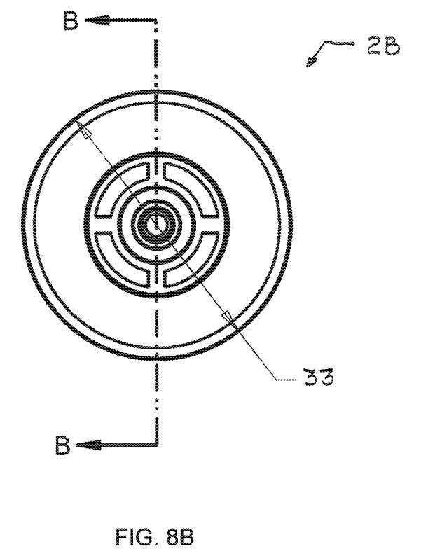

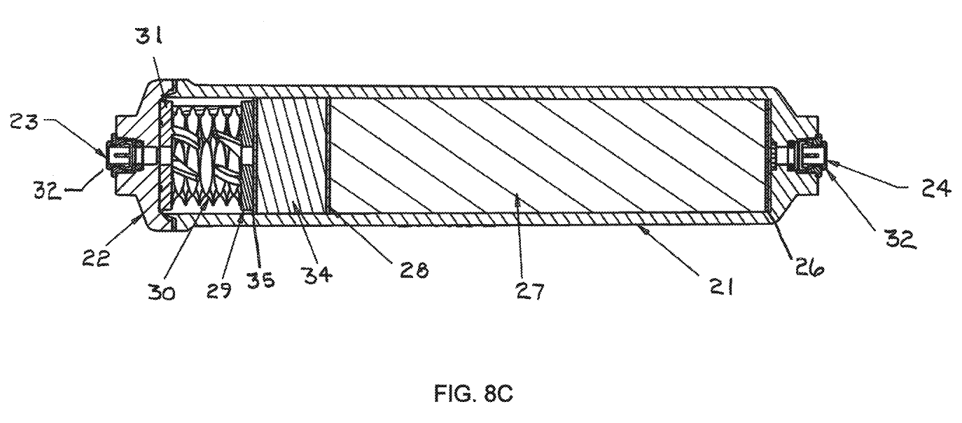

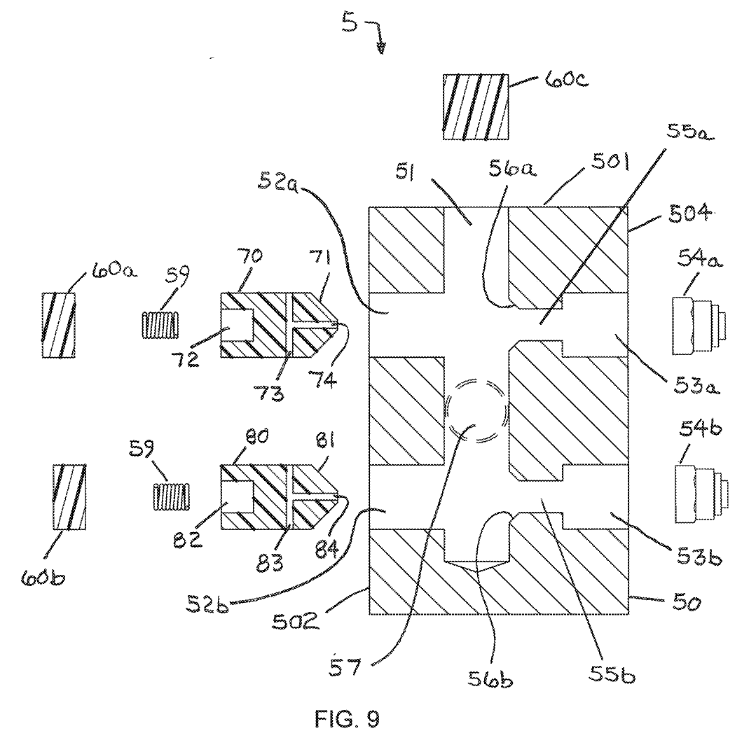

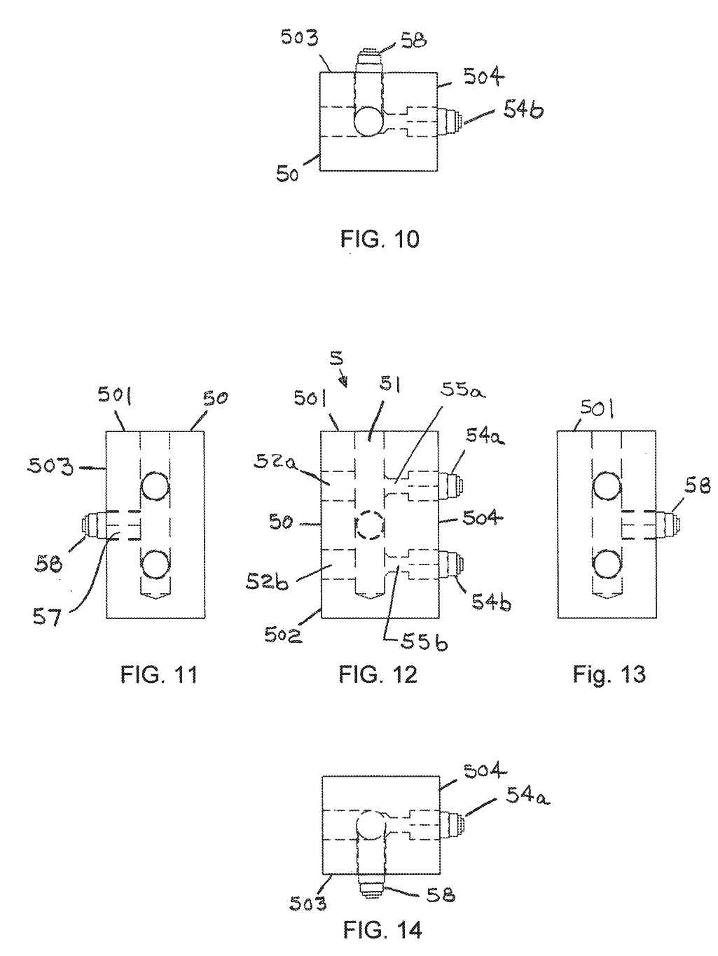

As shown in FIGS. 9-14, a flow block assembly 5 having a flow block 50, two bullet valves 70, 80, and at least two compression devices 59. The flow block 50 being a block shape and having one end 501, a first side 502, a second side 503, and a third side 504. The third side 504 is located opposite the first side 502. A first flow block channel 51 extending into the flow block 50 from the one end 501 of the flow block 50. Two second flow block channels 52a, 52b extending into the flow block 50 from the first side 502 of the flow block 50. Two flow block inlet channels 53a, 53b extending into the flow block 50 from the third side 504 of the flow block 50. Each flow block inlet port 54a, 54b of two flow block inlet ports 54a, 54b is connected to a corresponding flow block inlet channel 53a, 53b of the two flow block inlet channels 53a, 53b. Each flow block inlet port 54a, 54b of two flow block inlet ports 54a, 54b is connected via tubing to a corresponding outlet port 24 of the two filter cartridges 2. Two flow block intermediate channels 55a, 55b, each intermediate channel 55a, 55b of the two flow block intermediate channels 55a, 55b is located between and communicates with a corresponding one of the two flow block inlet channels 53a, 53b, the two second flow block channels 52a, 52b, and the first flow block channel 51. The two flow block intermediate channels 55a, 55b have a diameter than is smaller than a diameter of the two flow block inlet channels 53a, 53b and the first flow block channel 51. A flow block outlet channel 57 extending into the flow block 50 from the second side of the flow block 50, the flow block outlet channel 57 being connected to and communicating with the first flow block channel 51. An outlet port 58 is connected to the flow block outlet channel 57. The outlet port 58 is connected to tubing which releases oxygen when all the components are connected and the water oxygenation system is powered and turned on. An end of each intermediate channel of the two flow block intermediate channels 55a, 55b that is located adjacent to the first flow block channel 51 has a chamfered diameter 56a, 56b or a countersunk hole located adjacent to the first flow block channel 51. The outer end of each of the first flow block channel 51 and the two second flow block channels 52a, 52b are sealed or plugged (air tight seal) at the outer portion of the flow block 50 with three plugs 60a, 60b, 60c.

Two bullet valves 70, 80 are located in and move axially in the two second flow block channels 52a, 52b and move across the first flow block channel 51 and selectively into and out of the chamfered diameter 56a, 56b or a countersunk hole of the two flow block intermediate channels 55a, 55b. Each bullet valve 70, 80 is a cylindrical body and has a male seat 71, 81 located on a first end and a recess 72 located on a second end. Each bullet valve 70, 80 has a first regen hole 73, 83 and a second regen hole 74, 84 communicating with the first regen hole 73, 83. The first regen hole 73, 83 extends across a diameter of the bullet valve 70, 80 between the first end and the second end, and the second regen hole 74, 84 extends axially from the first end of the bullet valve 70, 80 to the fist regen hole. A diameter of the first regen hole 73, 83 is selected from a group consisting of a diameter that is less than, equal to, or greater than a diameter of the second regen hole 74, 84. Each male seat 71, 81 has a size and a shape matching and corresponding with the chamfered diameter 56a, 56b of the corresponding intermediate channel of the two flow block intermediate channels 55a, 55b. A compression device 59 is located in the recess 72 of each bullet valve 70, 80. The compression device 59 presses against a plug 60a, 60b located in the outer end of each second channel of the two second flow block channels 52a, 52b and each bullet valve 70, 80, and presses and biases each bullet valve 70, 80 towards the chamfered diameter 56a, 56b of the corresponding intermediate channel of the two flow block intermediate channels 55a, 55b. When there is no air pressure, the at least two compression devices 59 will press the two bullet valves 70, 80 into the chamfered diameter 56a, 56b of the corresponding intermediate channel of the two flow block intermediate channels 55a, 55b. The two compression devices 59 can be compression springs.

Each bullet valve 70, 80 is moveable between a first position and a second position. When the bullet valve 70, 80 is located in the first position, the bullet valve 70, 80 engages the chamfered diameter 56a, 56b of the two flow block intermediate channels 55a, 55b and prevents airflow therebetween. When the bullet valve 70, 80 is located in the second position, the bullet valve 70, 80 is pressed by air flow away from the chamfered diameter 56a, 56b of the two intermediate flow block channels 55a, 55b and airflows between one bullet valve 70, 80 and the chamfered diameter 56a, 56b of the two flow block intermediate channels 55a, 55b.

During operation, an air flow is reversible between a first air flow direction and a second air flow direction. In the first air flow direction, air flows through the first filter cartridge 211 at first air flow pressure (oxygen enriched air) into a first flow block inlet channel 53a of two flow block inlet channels 53a, 53b, through the first flow block intermediate channel 55a, between the first bullet valve 70 and the chamfered diameter 56a of the first flow block intermediate channel 55a (a smaller amount of air can also flow through the second regen hole 74 and the first regen hole 73 of the first bullet valve 70), through the first flow block channel 51, through both the flow block outlet channel 57 and the first regen hole 83 and the second regen hole 84 of the second bullet valve 80, through the second flow block intermediate channel 55b, through a second flow block inlet channel 53b of the two flow block inlet channels 53a, 53b, and though the second filter cartridge 212 at a second air flow pressure (reverse flow). In the first air flow direction, air flow enters from the first filter cartridge 211 and exits through the flow block outlet channel 57 and the second filter cartridge 212.

In the second air flow direction, air flows through the second filter cartridge 212 at a first air flow pressure (oxygen enriched air) into the second flow block inlet channel 53b of the two flow block inlet channels 53a, 53b, through the second flow block intermediate channel 55b, between the second bullet valve 80 and the chamfered diameter 56a, 56b of the second flow block intermediate channel 55b (a smaller amount of air can also flow through the second regen hole 84 and the first regen hole 83 of the second bullet valve 80), through the first flow block channel 51, through both the flow block outlet channel 57 and the first regen hole 73 and the second regen hole 74 of the first bullet valve 70, through the first flow block intermediate channel 55a, through the first flow block inlet channel 53a of the two flow block inlet channels 53a, 53b, and though the first filter cartridge 211 at a second air flow pressure (reverse flow). In the second air flow direction, air flow enters from the second filter cartridge 212 and exits through the flow block outlet channel 57 and the first filter cartridge 211.

The flow block 50 and two bullet valves 70, 80 can be made from a material selected from a group consisting of plastic materials, resins, metallic materials, metallic alloys, medical grade plastic materials, medical grade resins, medical grade metallic materials, medical grade metallic alloys, any application specific materials, or any combination thereof. The plastic materials or plastics include but are not limited to polyethylene terephthalate (PETE or PET), polyethylene (PE), polyvinyl chloride (PVC), polypropylene (PP), polystyrene (PS), polylactic acid (PLA), polycarbonate (PC), acrylic or polymethyl methacrylate (PMMA), acrylonitrile-butadiene-styrene (ABS), acetal (polyoxymethylene, POM), and nylon (PA).

### Two Filter Cartidges

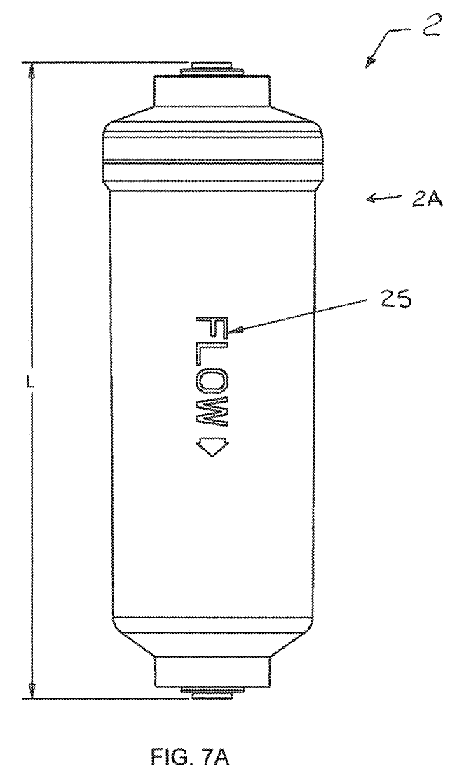

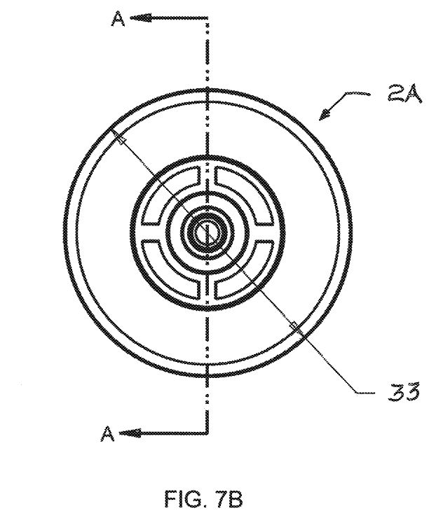

As shown in FIGS. 7A-8C, the two filter cartridges 2 include a first filter cartridge 211 and a second filter cartridge 212. The first filter cartridge 211 and the second filter cartridge 212 can be selected from a group of cartridges including an External Replaceable Nitrogen Small Filter Cartridge 2A and an External Replaceable Nitrogen Large Filter Cartridge 2B.

### External Replaceable Nitrogen Small Filter Cartridge

As shown in FIGS. 7A-7C, the external replaceable nitrogen small filter cartridge (small filter cartridge) 2A has a cartridge body 21 and a cartridge cap 22. The cartridge body 21 has a first end with a filter cartridge outlet port 24 and a second end that is open to a hollow interior chamber that is located between the first end and the second end of the cartridge body 21. The cartridge cap 22 has a cartridge cap inlet 23 and is connected to the second end of the cartridge body 21. A directional arrow 25 indicating the direction for air flow is printed on cartridge body 25.

The collet connector 32 or other suitable connector is placed into the filter cartridge outlet port 24 and the collet connector 32 or other suitable connector is placed into the cartridge cap inlet 23. The collet connector 32 can be any type of connector for connecting the cartridge body 21 to the tubing, including quick connect fittings, threaded fittings, fittings with nipples or any other suitable connector. A first felt disc 26 is made of felt or other suitable material and is positioned flat and level in the bottom of the cartridge body 21 at an outlet end of the filter cartridge 2. A predetermined amount (weight) of the nitrogen scrubbing material 27 (zeolite or other suitable material) is placed into cartridge body 21 on top of the first felt disc 26. A second felt disc 28 is placed on top of the nitrogen scrubbing material 27 and positioned flat and level in the cartridge body 21. A first disc spring 29 is positioned flat and level on top of the felt disc inside the cartridge body 21. A steel wave spring 30 is inserted into cartridge body 21 and located on top of the first disc spring 29 and positioned flat and level. A second disc spring 31 is placed on top of the steel wave spring 30 and positioned flat and level inside the cartridge body 21. The cartridge cap 22 is connected to the cartridge body 21. The first and second felt discs 26, 28 are made of felt or other suitable material.

The small filter cartridge has at least two felt discs that are axially moveable within an inner chamber of the filter cartridge.

### External Replaceable Nitrogen Large Filter Cartridge

As shown in FIGS. 8A-8C, the external replaceable nitrogen large filter cartridge (large filter cartridge) 2B has a cartridge body 21 and a cartridge cap 22. The cartridge body 21 has a first end with a filter cartridge outlet port 24 and a second end that is open to a hollow interior chamber that is located between the first end and the second end of the cartridge body 21. The cartridge cap 22 has a cartridge cap inlet 23 and is connected to the second end of the cartridge body 21. A directional arrow 25 indicating the direction for air flow is printed on cartridge body 25.

The collet connector 32 or other suitable connector is placed into the filter cartridge outlet port 24 and the collet connector 32 or other suitable connector is placed into the cartridge cap inlet 23. The collet connector 32 can be any type of connector for connecting the cartridge body 21 to the tubing, including quick connect fittings, threaded fittings, fittings with nipples or any other suitable connector. A first felt disc 26 is placed into the cartridge body 21 and positioned flat and level in the bottom of the cartridge body 21 at an outlet end of the filter cartridge 2. A predetermined amount (weight) of the nitrogen scrubbing material 27 (zeolite or other suitable material) is placed into cartridge body 21 on top of the first felt disc 26. A second felt disc 28 is located on top of the nitrogen scrubbing material 27 and positioned flat and level in the cartridge body 21. The first and second felt discs 26, 28 secure the nitrogen scrubbing material 27 within the cartridge body 21 while allowing for axial movement and/or separating the nitrogen scrubbing material 27 and a desiccant 34. A predetermined amount (weight) of the desiccant 34 is placed inside the cartridge body 21 on top of the second felt disc 28 that is positioned flat and level. A third felt disc 35 is placed on top of the desiccant flat and positioned level inside the cartridge body 21. A first disc spring 29 is placed on top of the third felt disc 35 and positioned flat and level inside the cartridge body 21. A steel wave spring 30 is placed flat and level on top of the first disc spring 29 inside the cartridge body 21. A second disc spring 31 is placed flat and level on top of the steel wave spring 30 inside the cartridge body 21. The cartridge cap 22 is placed on the cartridge body 21. The first, second, and third felt discs 26, 28, 35 are made of felt or other suitable material. Air flows through each of the felt discs 26, 28, 35.

The amount of nitrogen scrubbing material 27 can be more, less, or the same amount as the amount of desiccant 34. A nitrogen scrubbing material 27 to desiccant 34 ratio of 5:1 has shown outstanding results for the large filter cartridge. However, to produce oxygen, the ratio does not have to be a 5:1.

The large filter cartridge has at least three felt discs that are axially moveable within an inner chamber of the filter cartridge.

### External Replaceable Nitrogen Small and Large Filter Cartridges

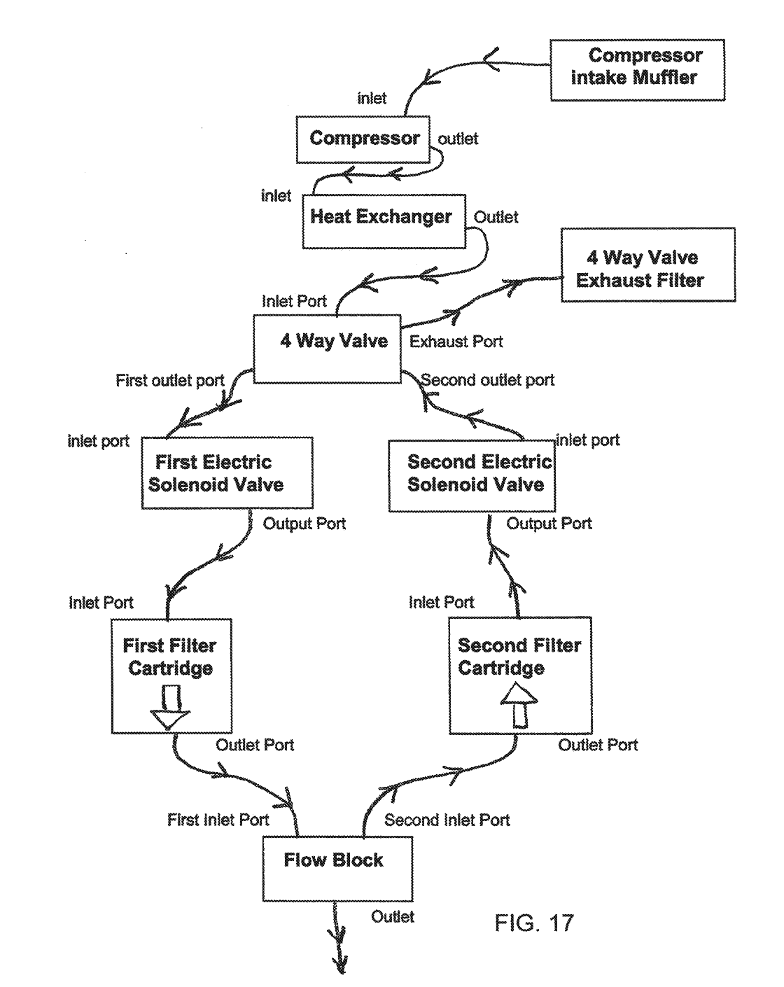

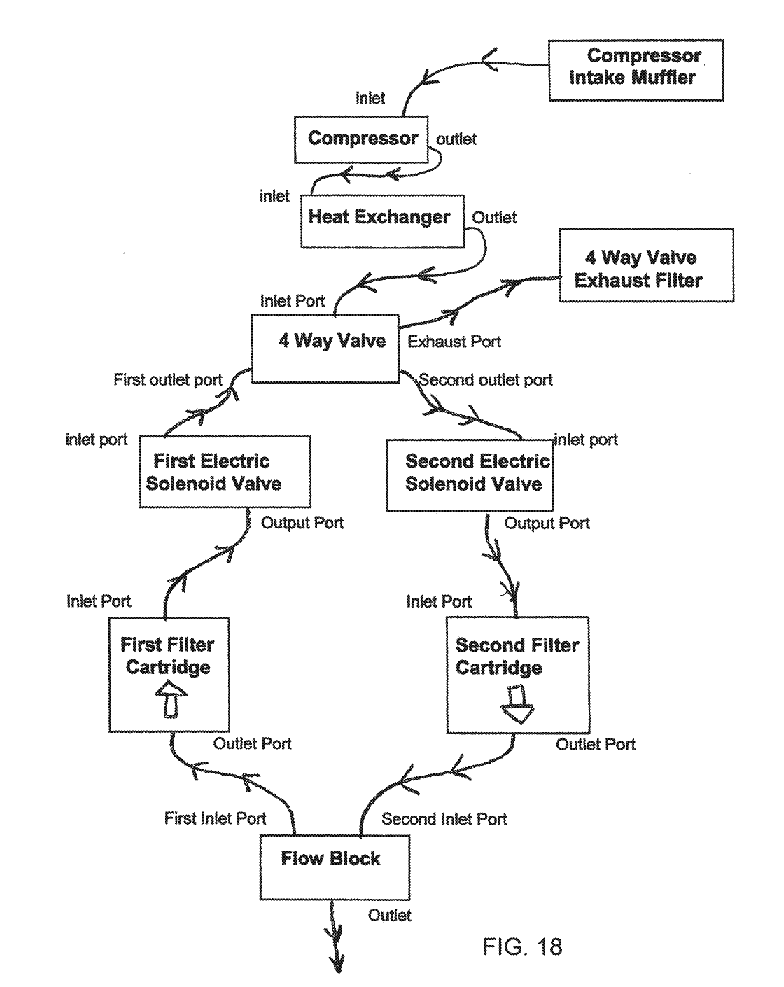

As shown in FIGS. 17-18, the external replaceable nitrogen filter cartridges were invented to help generate oxygen through a scrubbing or absorbing effect of the nitrogen scrubbing material 27. The air comes in the filter cartridge through the collet inlet. The air comes from the water oxygenation system under pressure and is forced over and around the nitrogen scrubbing material 27 causing nitrogen and other gases captured from the air resulting in highly concentrated oxygen output through the filter cartridge collet output which is connected to the filter cartridge outlet port 24 by tubing. The flow block 50 allows an alternating back pressure and release pressure resulting in oxygen output by working with the 4 way valve 18, the two electric solenoid valves 17 and the two filter cartridges 2. The combination of these valves, two filter cartridges 2 and the flow block 50 working together allows one filter cartridge to rest and recharge while the other filter cartridge is under pressure, removing nitrogen as well as other gases and then releasing oxygen through the collet output through tubing connect to the flow block inlet port 54a, 54b and released through the flow block outlet port 58 of the flow block 50.

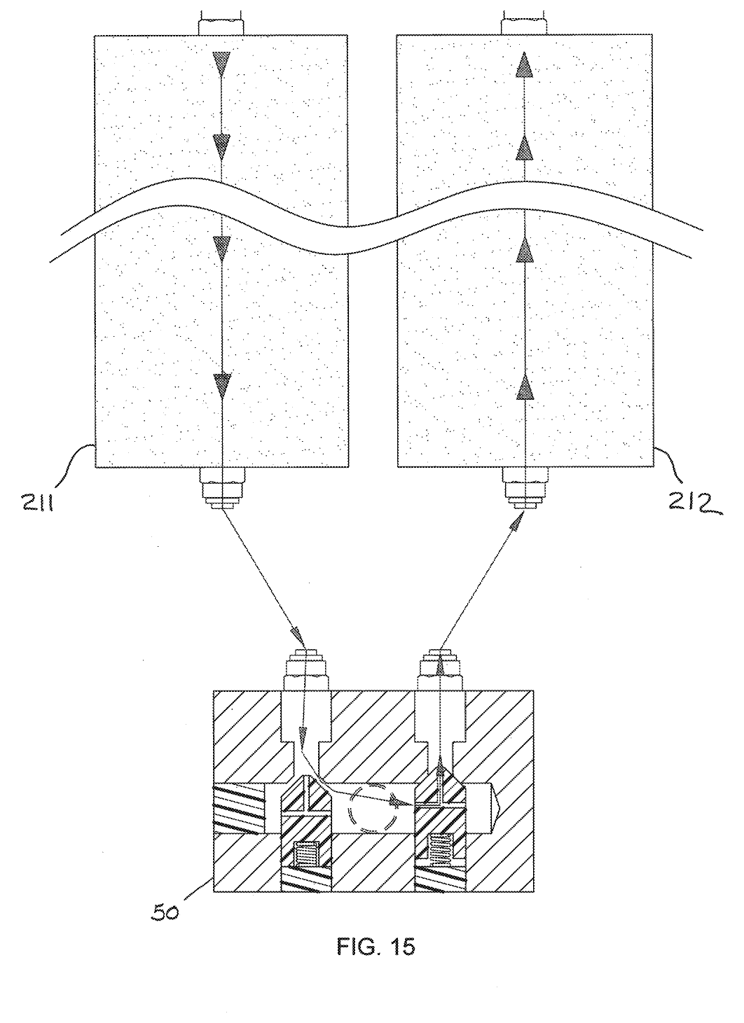

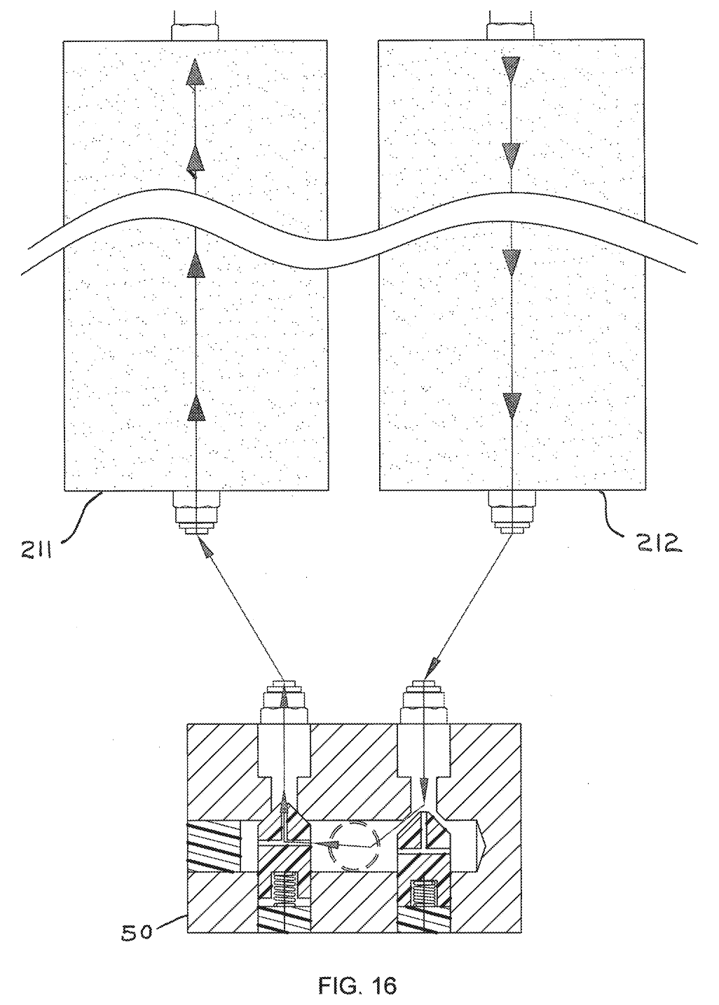

As shown in FIGS. 15-16, the air flow pressure flowing through each of the two filter cartridges 2 is controlled by the flow block 50 to alternate the direction and pressure of the air flowing through the first filter cartridge 211 and the second filter cartridge 212. The air flow pressure alternates between the first air flow pressure and the second air flow pressure.

When the bullet valves 70, 80 of the flow block 50 are located in a first position, the air flows through the first filter cartridge 211 in the first air flow direction at the first air flow pressure and through the second filter cartridge 212 in second air flow direction at the second air flow pressure.

When the bullet valves 70, 80 of the flow block 50 are located in a second position, the air flows through the first filter cartridge 211 in the second air flow direction at the second air flow pressure and through the second filter cartridge 212 in first air flow direction at the first air flow pressure.

The first air flow pressure is a higher pressure than the second air flow pressure. When the nitrogen scrubbing material 27 is exposed to the first air flow pressure, the nitrogen scrubbing material 27 absorbs nitrogen from the compressed air, thereby producing oxygen enriched air. When the nitrogen scrubbing material 27 is exposed to the second air flow pressure, the nitrogen scrubbing material 27 releases nitrogen into the compressed air, thereby producing oxygen enriched air.

The nitrogen scrubbing material 27 in the two filter cartridges 2 is a nitrogen absorbing material selected from a group comprising any nitrogen absorbing material including natural zeolites, synthetic zeolites, analcime, chabazite, clinoptilolite, heulandite, natrolite, phillipsite, stilbite, or a combination thereof.

The two filter cartridges 2 have a predetermined length l and predetermined outer diameter 33. The two filter cartridges 2 can have a cross section of any shape including a circle, oval, ellipse, polygon, or other irregular shape to accommodate a specific configuration to accommodate a predetermined configuration. However, a filter cartridge having a circular cross section provides the most efficient use of the nitrogen scrubbing material 27 by producing the highest oxygen concentration.

1. A water oxygenation system comprising:
two filter cartridges, each filter cartridge of the two filter cartridges having a cartridge body and a cartridge cap, the cartridge body has a first end with a filter cartridge outlet port and a second end that is open to a hollow interior chamber that is located between the first end and the second end of the cartridge body, the cartridge cap has a cartridge cap inlet and is connected to the second end of the cartridge body;
at least two felt discs including a first felt disc and a second felt disc; and
a predetermined amount of the nitrogen scrubbing material;
wherein the first felt disc is positioned flat and level in the bottom of the cartridge body at an outlet end of the filter cartridge; the predetermined amount of the nitrogen scrubbing material is placed into cartridge body on top of the first felt disc; the second felt disc is placed on top of the nitrogen scrubbing material and positioned flat and level in the cartridge body; and the cartridge cap is connected to the cartridge body.

2. The water oxygenation system according to claim 1, further comprising:
at least two disc springs including a first disc spring and a second disc spring;
a steel wave spring;
wherein the first disc spring is positioned flat and level on top of the second felt disc inside the cartridge body; and the steel wave spring is inserted into cartridge body and located on top of the first disc spring and positioned flat and level; the second disc spring is placed on top of the steel wave spring and positioned flat and level inside the cartridge body.

3. The water oxygenation system according to claim 1, further comprising:
a predetermined amount of desiccant is placed inside the cartridge body on top of the second felt disc; and
the at least two felt discs includes a third felt disc, the third felt disc is placed on top of the predetermined amount of desiccant flat and positioned level inside the cartridge body.

4. The water oxygenation system according to claim 3, further comprising:
at least two disc springs including a first disc spring and a second disc spring;
a steel wave spring;
wherein the first disc spring is positioned flat and level on top of the third felt disc inside the cartridge body; and the steel wave spring is inserted into cartridge body and located on top of the first disc spring and positioned flat and level; the second disc spring is placed on top of the steel wave spring and positioned flat and level inside the cartridge body.

5. The water oxygenation system according to claim 1, wherein an air flow pressure flowing through each of the two filter cartridges is controlled by a flow block to alternate the direction and pressure of the air flowing through the first filter cartridge and the second filter cartridge, the air flow pressure alternates between a first air flow pressure and a second air flow pressure;
wherein the first air flow pressure is a higher pressure than the second air flow pressure; and
wherein, when the nitrogen scrubbing material is exposed to the first air flow pressure, the nitrogen scrubbing material absorbs nitrogen from the compressed air, thereby producing oxygen enriched air, and, when the nitrogen scrubbing material is exposed to the second air flow pressure, the nitrogen scrubbing material releases nitrogen into the compressed air, thereby producing oxygen enriched air.

6. The water oxygenation system according to claim 1, wherein the cartridge body has a directional arrow indicating the direction for air flow is printed on the cartridge body.

7. The water oxygenation system according to claim 1, wherein the predetermined amount of the nitrogen scrubbing material is selected from a group comprising any nitrogen absorbing material including natural zeolites, synthetic zeolites, analcime, chabazite, clinoptilolite, heulandite, natrolite, phillipsite, stilbite, or a combination thereof.

8. The water oxygenation system according to claim 1, wherein the at least two felt discs are made of felt or other suitable material.

9. The water oxygenation system according to claim 1, further comprising:
a flow block assembly having a flow block, two bullet valves, and at least two compression devices;
the flow block being a block shape and having one end, a first side, a second side, and a third side, the third side is located opposite the first side; a first flow block channel extend into the flow block from the one end of the flow block; two second flow block channels extend into the flow block from the first side of the flow block; two flow block inlet channels extend into the flow block from the third side of the flow block; two flow block intermediate channels, each intermediate channel of the two flow block intermediate channels is located between and communicates with a corresponding one of the two flow block inlet channels, the two second flow block channels, and the first flow block channel; and a flow block outlet channel extends into the flow block from the second side of the flow block, the flow block outlet channel being connected to and communicating with the first flow block channel; an end of each intermediate channel of the two flow block intermediate channels that is located adjacent to the first flow block channel has a chamfered diameter located adjacent to the first flow block channel;
two bullet valves are located in and move axially in the two second flow block channels and move across the first flow block channel and selectively into and out of the chamfered diameter of the two flow block intermediate channels, each bullet valve of the two bullet valves is a cylindrical body and has a male seat located on a first end and a recess located on a second end, each bullet valve has a first regen hole and a second regen hole communicating with the first regen hole, the first regen hole extends across a diameter of the bullet valve between the first end and the second end, and the second regen hole extends axially from the first end of the bullet valve to the fist regen hole;
two compression devices 59, one compression device of the two compression devices is located in the recess of each bullet valve, the compression device presses against a plug located in the outer end of each second channel of the two second flow block channels and each bullet valve, and presses and biases each bullet valve towards the chamfered diameter of the corresponding intermediate channel of the two flow block intermediate channels, when there is no air pressure, the at least two compression devices press the two bullet valves into the chamfered diameter of the corresponding intermediate channel of the two flow block intermediate channels; and
three plugs, the outer end of each of the first flow block channel and the two second flow block channels are sealed at an outer portion of the flow block with three plugs.

10. The water oxygenation system according to claim 9, further comprising:
two flow block inlet ports, each flow block inlet port of the two flow block inlet ports is connected to a corresponding flow block inlet channel of the two flow block inlet channels, each said flow block inlet port of two flow block inlet ports is connected via tubing to a corresponding outlet port of a corresponding filter cartridge of the two filter cartridges; and
an outlet port is connected to the flow block outlet channel, when the water oxygenation system is operating, oxygen enriched air is released through the outlet port.

11. The water oxygenation system according to claim 9, wherein the two flow block intermediate channels have a diameter than is smaller than a diameter of the two flow block inlet channels and the first flow block channel.

12. The water oxygenation system according to claim 9, wherein a diameter of the first regen hole is selected from a group consisting of a diameter that is less than, equal to, or greater than a diameter of the second regen hole, each male seat has a size and a shape matching and corresponding with the chamfered diameter of the corresponding intermediate channel of the two flow block intermediate channels.

13. The water oxygenation system according to claim 9, wherein the two compression devices are compression springs.

14. The water oxygenation system according to claim 9, wherein each bullet valve is moveable between a first position and a second position;
wherein, when the bullet valve is located in the first position, the bullet valve engages the chamfered diameter of the two flow block intermediate channels and prevents airflow therebetween;
wherein, when the bullet valve is located in the second position, the bullet valve is pressed by air flow away from the chamfered diameter of the two intermediate flow block channels and airflows between one bullet valve and the chamfered diameter of the two flow block intermediate channels;
wherein, during operation of the water oxygenation system, an air flow is reversible between a first air flow direction and a second air flow direction;
wherein, when the air flow is in the first air flow direction, the air flows through a first filter cartridge of the two filter cartridges at a first air flow pressure into the first flow block inlet channel of two flow block inlet channels, through the first flow block intermediate channel, between the first bullet valve and the chamfered diameter of the first flow block intermediate channel, a smaller amount of air flows through the second regen hole and the first regen hole of the first bullet valve, through the first flow block channel, through both the flow block outlet channel and the first regen hole and the second regen hole of the second bullet valve, through the second flow block intermediate channel, through a second flow block inlet channel of the two flow block inlet channels, and though the second filter cartridge at a second air flow pressure;
wherein, when the air flow is in the first air flow direction, air flow enters from the first filter cartridge and exits through the flow block outlet channel and the second filter cartridge;
wherein, when the air flow is in the second air flow direction, the air flows through the second filter cartridge at the first air flow pressure into the second flow block inlet channel of the two flow block inlet channels, through the second flow block intermediate channel, between the second bullet valve and the chamfered diameter of the second flow block intermediate channel, a smaller amount of air can also flow through the second regen hole and the first regen hole of the second bullet valve, through the first flow block channel, through both the flow block outlet channel and the first regen hole and the second regen hole of the first bullet valve, through the first flow block intermediate channel, through the first flow block inlet channel of the two flow block inlet channels, and though the first filter cartridge at the second air flow pressure;
wherein, when the air flow is in the second air flow direction, the air flow enters from the second filter cartridge and exits through the flow block outlet channel and the first filter cartridge.

15. The water oxygenation system according to claim 9, wherein the flow block and two bullet valves are made from a material selected from a group consisting of plastic materials, resins, metallic materials, metallic alloys, medical grade plastic materials, medical grade resins, medical grade metallic materials, medical grade metallic alloys, any application specific materials, or any combination thereof, the plastic materials include but are not limited to polyethylene terephthalate (PETE or PET), polyethylene (PE), polyvinyl chloride (PVC), polypropylene (PP), polystyrene (PS), polylactic acid (PLA), polycarbonate (PC), acrylic or polymethyl methacrylate (PMMA), acrylonitrile-butadiene-styrene (ABS), acetal (polyoxymethylene, POM), and nylon (PA).

16. The water oxygenation system according to claim 1, further comprising:
a base plate;
a printed circuit board connected to the base plate and electrically connected to a power supply;
a heat exchanger fan is connected to base plate and electrically connected to the printed circuit board, the heat exchanger fan blows air across the heat exchanger to remove heat from the air flowing through the heat exchanger;
a 4 way valve is connected to the base plate and electrically connected to the printed circuit board, the 4 way valve has an exhaust filter;
two electric solenoid valves are connected to base plate and electrically connected to the printed circuit board, and each electric solenoid valve inlet port is connected to the 4 way valve outlet ports with tubing;
a compressor having a compressor intake filter and electrically connected to the printed circuit board and each of the two electric solenoid valves, the compressor provides compressed air and a pressurized air flow;
the compressor, the heat exchanger, the 4 way valve, the two electric solenoid valves, the two filter cartridges, a flow block, the compressor intake filter, and the exhaust filter connected to the 4 way valve are connected by tubing;
a heat exchanger inlet of the heat exchanger is connected to a compressor outlet of the compressor with tubing and a heat exchanger outlet of the heat exchanger is connected with tubing to a 4 way valve inlet port of the 4 way valve;
an exhaust filter is connected by tubing to an exhaust port of the 4 way valve;
a compressor intake filter connects to the intake port of the compressor with tubing;
a housing includes a housing lid that removably covers and seals the housing; the base plate, the printed circuit board, the heat exchanger, the heat exchanger fan, the 4 way valve, the two electric solenoid valves, compressor.

17. The water oxygenation system according to claim 16, further comprising:
at least one housing vent includes at least one ventilation cover and an opening, the opening communicates with the interior and the exterior of the housing, the at least one housing vent includes two housing vents, each housing vent is connected to one housing cooling fan, the two housing vents are connected to an opening located at either end of the housing and the housing cooling fan is connected to one end of the housing at the housing vent 6 and the housing cooling fan is electrically connected to the printed circuit board.

18. The water oxygenation system according to claim 16, further comprising:
four compressor mounting isolators are connected to base plate and are connected to the compressor.

19. The water oxygenation system according to claim 16, further comprising:
an output tubing line and an output tubing line connect each filter cartridge of the two filter cartridges to a corresponding electrical solenoid valve output port of each electric solenoid valve of the two electric solenoid valves, each filter cartridge is connected by tubing from the filter cartridge outlet port to one of two flow block inlet ports of the flow block by tubing, flow block inlet ports are connected to corresponding filter cartridge outlet ports by tubing and a flow block outlet port is connected to tubing which is connected to a one way check valve that is connected to at least one defusing stone.

20. The water oxygenation system according to claim 16, wherein the heat exchanger is made of metal, copper, copper alloy, or other suitable material to provide a transfer of heat from the air flow.
